(19) United States
(12) Patent Application Publication
(10) Pub. No.: US 2025/0278222 A1
(43) Pub. Date: Sep. 4, 2025

(54) PRINT CONTROL SYSTEM, NON-TRANSITORY COMPUTER READABLE MEDIUM, AND METHOD

(71) Applicant: FUJIFILM Business Innovation Corp., Tokyo (JP)

(72) Inventor: Satoshi MISAWA, Kanagawa (JP)

(73) Assignee: FUJIFILM Business Innovation Corp., Tokyo (JP)

(21) Appl. No.: 18/760,139

(22) Filed: Jul. 1, 2024

(30) Foreign Application Priority Data
Feb. 29, 2024 (JP) 2024-030672

(51) Int. Cl. G06F 3/12; G06T 7/00

(52) U.S. Cl. CPC G06F 3/1215; G06F 3/1259; G06F 3/1281; G06T 7/0004; G06T 2207/30144

(57) ABSTRACT

A print control system includes a processor configured to: acquire environmental information on an environment where a printer is installed; set an inspection level responsive to the acquired environmental information on an inspection apparatus that inspects a printed material on the printer; calculate an inspection speed when the inspection apparatus inspects the printed material at the inspection level set on the inspection apparatus; and control the printer such that printing is performed at a print speed responsive to the calculated inspection speed.

### CROSS-REFERENCE TO RELATED APPLICATIONS

This application is based on and claims priority under 35 USC 119 from Japanese Patent Application No. 2024-030672 filed Feb. 29, 2024.

### BACKGROUND

### (i) Technical Field

The present disclosure relates to a print control system, a non-transitory computer readable medium, and a method.

### (ii) Related Art

Japanese Unexamined Patent Application Publication No. 11-170489 discloses a system that centrally manages multiple printed-material image inspection apparatuses by connecting the apparatuses via a general-purpose network.

Japanese Unexamined Patent Application Publication No. 2003-276278 discloses a printing system that includes multiple printers connected via a network and adjusts calibration intervals on one printer in accordance with calibration results and environmental information on another printer.

Multiple printing lines including printers are installed in a printing factory that performs commercial printing. The printers even operating in the same environmental area serving as the printing factory may be different from each other in terms of optimum environmental condition, such as temperature and humidity. Since printing quality of a printing system performing printing on printing paper is subject to the environmental condition, such as temperature and humidity, the printing quality may be degraded if the printing system is operated in an environmental state deviated from the optimum environmental condition.

Printing systems performing commercial printing inspect printing results to assure quality of printed materials. As an inspection level is set to be stricter in the inspection of the printed materials, quality of printing results is improved but inspection time is prolonged. In commercial printing process, time from ordering to delivery may be limited and cost reduction of the printing materials may be requested. Higher productivity may thus be requested. But constantly applying a stricter inspection level is not necessarily sufficient.

### SUMMARY

Aspects of non-limiting embodiments of the present disclosure relate to providing a print control system, a non-transitory computer readable medium and a method that, when an inspection apparatus inspects a printed material from a printer, set on the inspection apparatus an inspection level responsive to an environmental condition of an environment where the printer is installed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a print control system including a processor configured to: acquire environmental information on an environment where a printer is installed; set, on an inspection apparatus that inspects a printed material on the printer, an inspection level responsive to the acquired environmental information; calculate an inspection speed when the inspection apparatus inspects the printed material at the inspection level set on the inspection apparatus; and control the printer such that printing is performed at a print speed responsive to the calculated inspection speed.

### BRIEF DESCRIPTION OF THE DRAWINGS

Exemplary embodiment of the present disclosure will be described in detail based on the following figures, wherein:

FIG. 1 illustrates a configuration of a print control system according to an exemplary embodiment of the disclosure;

FIG. 2 is a block diagram illustrating a hardware configuration of a print control server according to the exemplary embodiment of the disclosure;

FIG. 3 is a block diagram illustrating a functional configuration of the print control server according to the exemplary embodiment of the disclosure;

FIG. 4 illustrates an example of a setting screen when an inspection level is set on each of combinations of temperature and humidity in response to an operation of an operation input unit; and

FIG. 5 is a flowchart illustrating an operation of the print control system according to the exemplary embodiment of the disclosure.

### DETAILED DESCRIPTION

Exemplary embodiment of the disclosure is described below with reference to the drawings.

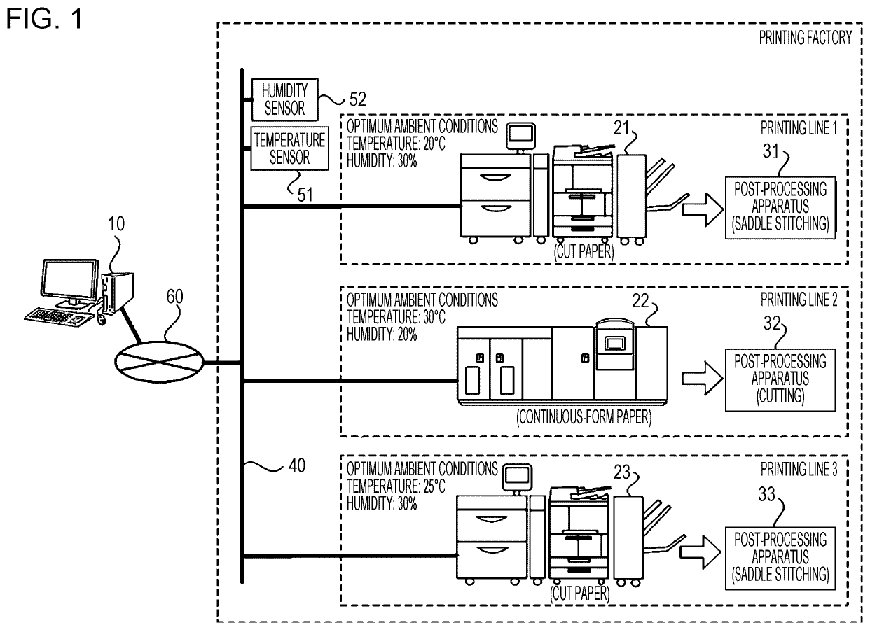

FIG. 1 illustrates a system configuration of a print control system according to an exemplary embodiment of the disclosure.

In the print control system of the exemplary embodiment of the disclosure as illustrated in FIG. 1, printers 21 through 23, post-processing apparatuses 31 through 33, temperature sensor 51 and humidity sensor 52 installed in a printing factory are connected to a print control server 10 via a network 40 in the printing factory and the Internet 60.

The post-processing apparatuses 31 through 33 perform post-processing of printed materials respectively printed by the printers 21 through 23. Specifically, the post-processing apparatuses 31 and 33 perform a saddle-stitching operation on the printed materials printed by the printers 21 and 23. The post-processing apparatus 32 performs a cutting operation on the printed materials printed by the printer 22.

A printing system including the printer 21 and post-processing apparatus 31 forms a printing line 1 and a printing system including the printer 22 and post-processing apparatus 32 forms a printing line 2. A printing system including the printer 23 and post-processing apparatus 33 forms a printing line 3.

According to the exemplary embodiment, the three printing lines 1 through 3 serving as lines of printers are installed in the printing factory.

Printing quality of the printers 21 through 23 performing printing on printing paper is sensitive to a change in the environment, such as temperature change and humidity change and an optimum environmental condition stabilizing each printing quality is present.

For example, the optimum environmental condition of the printing line 1 including the printer 21 and post-processing apparatus 31 is a temperature of 20° C. and a humidity of 30%. The optimum environmental condition of the printing line 2 including the printer 22 and post-processing apparatus 32 is a temperature of 30° C. and a humidity of 20%. The optimum environmental condition of the printing line 3 including the printer 23 and post-processing apparatus 33 is a temperature of 20° C. and a humidity of 30%.

The temperature sensor 51 detecting temperature in an environmental region such as the printing factory and the humidity sensor 52 detecting humidity in the environmental region such as the printing factory are installed in the printing factory. The print control server 10 acquires environmental information on the printing factory from the temperature sensor 51 and humidity sensor 52 and controls the operation of the printing lines 1 through 3 in accordance with the acquired environmental information.

If multiple printing systems are installed in the printing factory and the optimum environmental conditions of the printing systems are different from each other, it is difficult to realize an environment optimum for all the printing systems. Since the printing quality of each printing system is affected by the environmental condition, such temperature and humidity, the printing quality may be degraded with the printing system operating in an environmental state deviated from the optimum environmental condition.

In the printing system performing commercial printing, printing results are inspected to assure the quality of the printed material. As the inspection level is set to be stricter in the inspection of the printing results, the quality of the printing results is improved but the inspection time may be prolonged. In commercial printing process, time from ordering to delivery may be limited and cost reduction of the printing materials may be requested. Higher productivity may thus be requested. But constantly applying a stricter inspection level is not necessarily sufficient.

When the print control server 10 of the exemplary embodiment controls via the Internet 60 and network 40 the operation of the three printing lines 1 through 3 different in terms of the optimum environmental condition, the print control server 10 maintains the quality of the printed materials output from the printing lines 1 through 3 by performing control as described below.

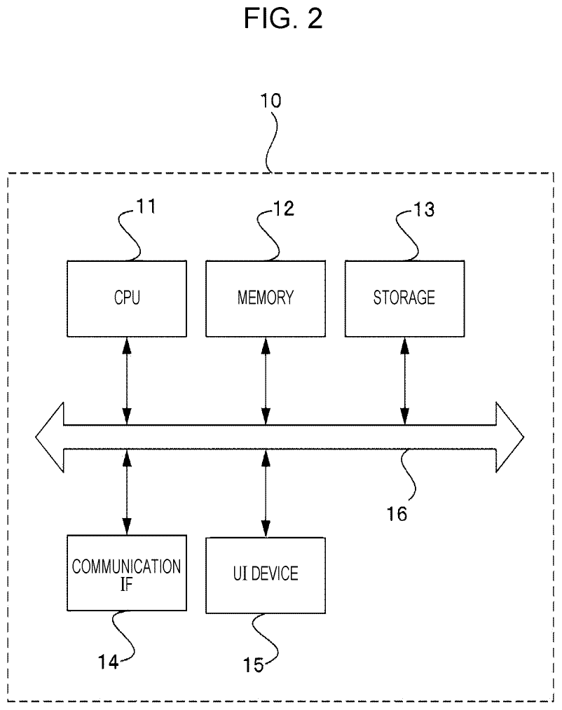

FIG. 2 is a block diagram illustrating a hardware configuration of the print control server 10 according to the exemplary embodiment of the disclosure.

Referring to FIG. 2, the print control server 10 includes a central processing unit (CPU) 11, memory 12, storage 13, such as a hard disk drive, communication interface (IF) 14 that transmits data to or receives data from an external apparatus via the network 30 and user interface (UI) device 15 that includes a keyboard and a touch panel or a liquid-crystal display. These elements are interconnected to each other via a control bus 16.

The CPU 11 controls the operation of the print control server 10 by performing a predetermined process responsive to a control program stored on the memory 12 or storage 13. According to the exemplary embodiment, the CPU 11 reads the control program from the memory 12 or storage 13 and executes the read control program. The disclosure is not limited to this method. Alternatively, the control program may be delivered in a recorded form on a computer readable recording medium. For example, the control program may be delivered in a recorded form on an optical disc, such as a compact disc read-only memory (CD-ROM) or digital versatile ROM (DVD-ROM), or a semiconductor memory such as a universal serial bus (USB) memory or memory card. The control program may be delivered from an external apparatus via a communication network connected to the communication IF 14.

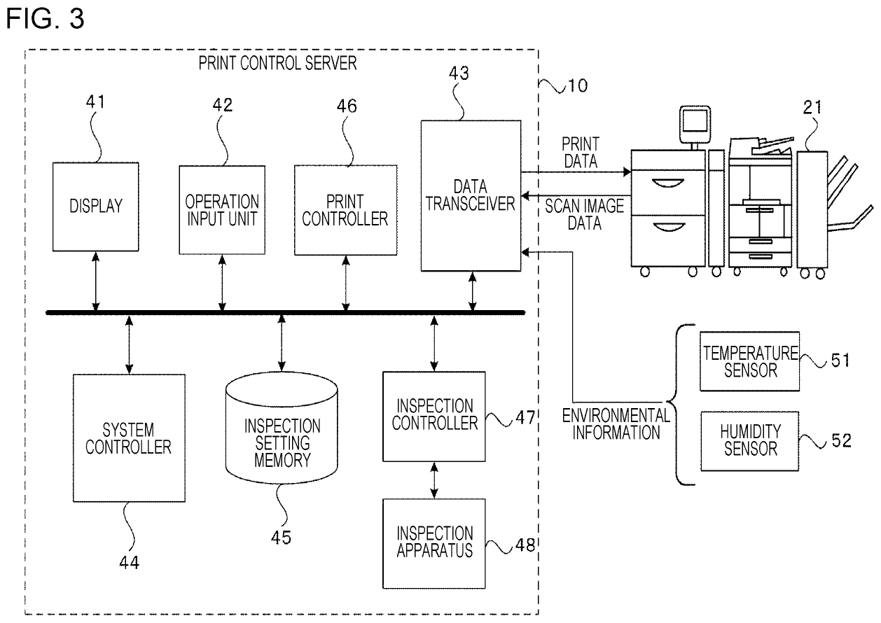

FIG. 3 is a functional block diagram of the image forming apparatus 10 that is implemented by performing the control program.

Referring to FIG. 3, the print control server 10 of the exemplary embodiment includes a display 41, operation input unit 42, data transceiver 43, system controller 44, inspection setting memory 45, print controller 46, inspection controller 47 and inspection apparatus 48.

The operation input unit 42 receives a variety of inputs from a user. The display 41, controlled by the system controller 44 displays a variety of information to the user. The data transceiver 43 exchanges data with the temperature sensor 51, humidity sensor 52, printers 21 through 23 and post-processing apparatuses 31 through 33 via the Internet 60 and network 40.

The system controller 44 controls the whole operation of the print control server 10. In order to perform a printing process on the printers 21 through 23 and the post-processing apparatuses 31 through 33, the system controller 44 instructs the print controller 46 to perform the printing process. The system controller 44 also instructs the inspection controller 47 to inspect printing results provided by the printers 21 through 23 and receives inspection results from the inspection controller 47.

In response to the command from the system controller 44, the print controller 46 transmits print data to the printers 21 through 23 and post-processing apparatuses 31 through 33 while transferring to the inspection controller 47 image data as a result of printing.

The inspection setting memory 45 stores an inspection setting table where an inspection level is set on each of the combinations of temperature and humidity.

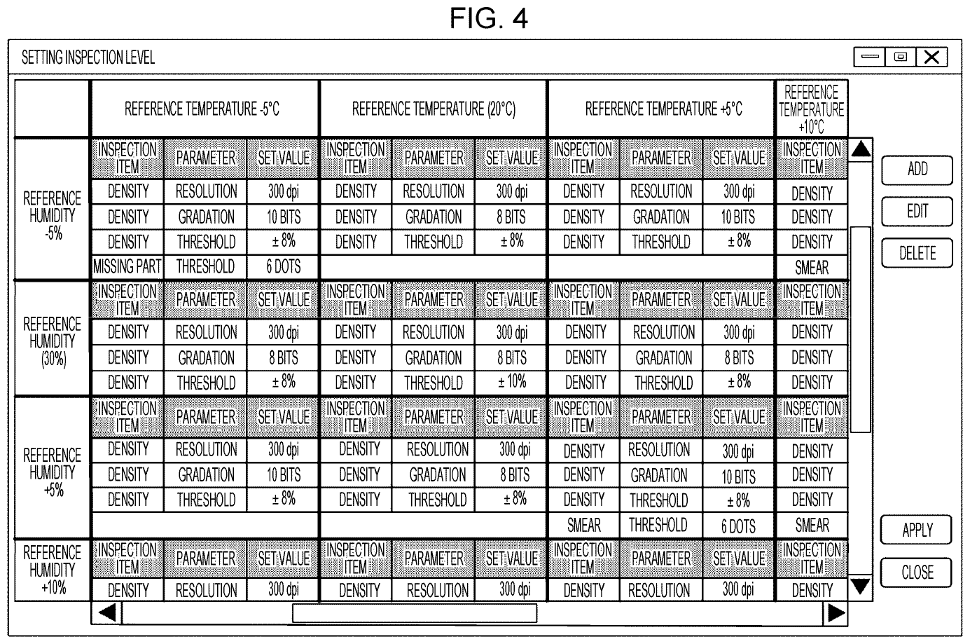

FIG. 4 illustrates an example of a setting screen displayed when the inspection level is set on each of the combinations of temperature and humidity in response to an operation of the operation input unit 42.

FIG. 4 illustrates the setting screen where the inspection level is set on each of the combinations of temperature and humidity in the inspection apparatus 48 having a temperature of 20° C. and a humidity of 30% as the optimum environmental condition. Referring to FIG. 4, under a temperature of 20° C. and a humidity of 30% as the optimum environmental condition, a resolution in a density inspection of printed image is set to be 300 dpi (dots per inch), a gradation is set to be 8 bits, and a threshold is set to be ±10%.

If the temperature in the printing factory is a reference temperature of −5° C., namely, 15° C. and the humidity in the printing factory is a reference humidity of −5%, namely, 25%, the inspection level is set to be stricter such that the resolution in the density inspection of the printed image is set to be 300 dpi, the gradation is set to be 10 bits, and the threshold is set to be ±8%. It is noted that under this environmental condition, an inspection item “void” used to inspect a void that is a missing portion of an image is added. The inspection setting table of the inspection level indicates that as the reference values are deviated more from the optimum environmental condition, a stricter inspection level is applied.

In response to temperature information and humidity information inside the printing factory acquired from the temperature sensor 51 and humidity sensor 52, the inspection controller 47 acquires from the inspection setting table stored on the inspection setting memory 45 information on the inspection level responsive to the current environmental state inside the printing factory and sets the inspection level in the inspection apparatus 48. Specifically, the inspection controller 47 acquires the environmental information on the inside of the printing factory where the printers 21 through 23 are installed and then sets the inspection level responsive to the acquired environmental information on the inspection apparatus 48 that inspects the printed materials on the printers 21 through 23. In order to inspect the printing results, the inspection controller 47 transfers to the inspection apparatus 48 scan data that results from scanning the printing results of printing on the printers 21 through 23 and image data from the print controller 46.

The inspection apparatus 48 performs inspection by comparing the scan data and the image data transferred from the print controller 46 with a preset inspection level and transmits inspection results to the inspection controller 47. The inspection controller 47 transfers the received inspection results to the system controller 44.

In response to the inspection results transferred from the inspection controller 47, the system controller 44 suspends a printing process or performs a reprint process starting with a page that is detected as a print fault.

The inspection controller 47 calculates an inspection speed with which the inspection is performed at the inspection level set on the inspection apparatus 48 and then notifies the print controller 46 of the inspection speed. The print controller 46 controls the printers 21 through 23 such that printing is performed at a print speed responsive to the calculated inspection speed.

If the environmental condition in the printing factory is greatly deviated from the optimum environmental condition of a printing line, there is a possibility that the print speed of the printing line is greatly reduced. If there are multiple printing lines respectively including the printers 21 through 23, the print controller 46 may reference the print speeds respectively set on the printers 21 through 23, select from the printers 21 through 23 a printer that is to perform a new print job and cause the selected printer to perform the new print job.

When the multiple printing lines are used to perform a single print job, the print controller 46 may reference the print speeds respectively set on the printers 21 through 23, select from the printers 21 through 23 a subset of printers, split the print job and cause the printers in the selected subset to respectively perform the split jobs.

According to the exemplary embodiment, the environmental information includes the temperature information and humidity information but may be a piece of information other than the temperature information and humidity information. According to the exemplary embodiment, the inspection level includes an inspection item, an inspection criterion and an inspection accuracy, wherein the inspection item indicates an item of the printed material that serves as an inspection target, the inspection criterion serves as a standard according to which a pass-or-fail judgement is performed on the printed material and the inspection accuracy is used in the inspection. At least one of the inspection item, the inspection criterion and the inspection accuracy may be used as the inspection level.

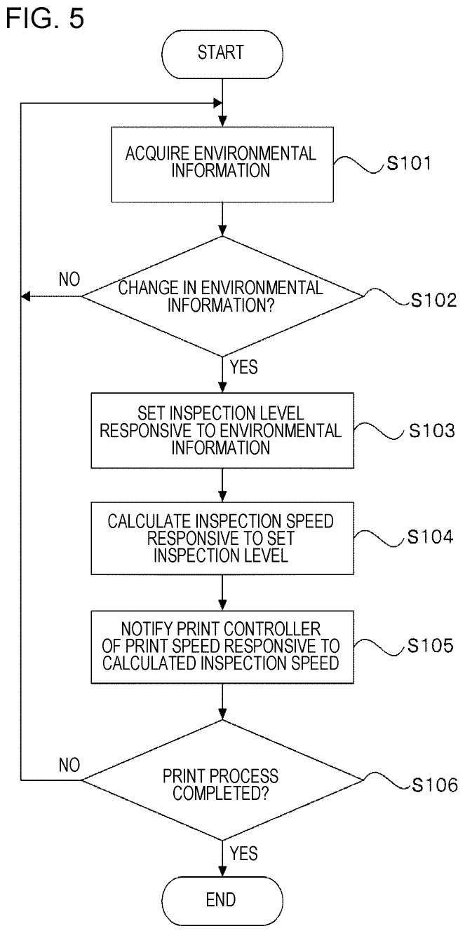

The operation of the print control system of the exemplary embodiment is described in detail with reference to a flowchart in FIG. 5.

When a print job is performed, the inspection controller 47 acquires the temperature information and humidity information from the temperature sensor 51 and humidity sensor 52 in the printing factory in step S101.

The inspection controller 47 determines in step S102 whether the environmental information currently acquired has changed from the previously acquired environmental information.

If the inspection controller 47 determines in step S102 that the environmental information currently acquired has not changed from the previously acquired environmental information, the inspection controller 47 acquires periodically the environmental information of the printing factory in accordance with the operation in step S101.

If the inspection controller 47 determines in step S102 that the environmental information currently acquired has changed from the previously acquired environmental information, the inspection controller 47 acquires in step S103 the inspection level responsive to the acquired environmental information from the inspection setting table stored on the inspection setting memory 45.

The inspection controller 47 calculates the inspection speed responsive to the set inspection level in step S104. In step S105, the inspection controller 47 notifies the print controller 46 of the print speed responsive to the calculated inspection speed.

The print controller 46 adjusts the print speeds of the printers 21 through 23 such that the printing is performed at the print speed notified by the inspection controller 47.

In step S106, the inspection controller 47 determines in step S106 whether the printing process is complete and if the printing process is complete, the print controller 46 ends the operation. If the inspection controller 47 determines that the printing process is not complete, processing returns to step S101.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the embodiments above, and may be changed.

The term “system” in the exemplary embodiment may include a single apparatus or multiple apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A print control system including:
a processor configured to:
acquire environmental information on an environment where a printer is installed;
set, on an inspection apparatus that inspects a printed material on the printer, an inspection level responsive to the acquired environmental information;
calculate an inspection speed when the inspection apparatus inspects the printed material at the inspection level set on the inspection apparatus; and
control the printer such that printing is performed at a print speed responsive to the calculated inspection speed.
   (((2)))

In the print control system according to (((1))), the processor is configured to:
if a plurality of printing lines respectively including printers are present, select, by referencing the print speeds respectively set on the printers, from the printers a printer that is to execute a new print command and
cause the selected printer to execute the new print command.
   (((3)))

In the print control system according to (((2))), the processor is configured to:
if a print command is executed using a subset of printing lines, select, by referencing the print speeds respectively set on the printers, from the printers a subset of printers that is to execute a new print command and
split the new print command and cause the selected subset of printers to execute the split new print commands.
   (((4)))

In the print control system according to any one of (((1))) through (((3))), the environmental information includes temperature information and humidity information, and
the inspection level is set in accordance with at least one of an inspection item, an inspection criterion or an inspection accuracy, the inspection item indicating an item of the printed material that serves as an inspection target, the inspection criterion being a standard according to which a pass-or-fail judgement is performed on the printed material and the inspection accuracy used in inspection.
   (((5)))

In the print control system according to (((4))), the processor is configured to, in accordance with a table where the inspection level is listed on each combination of temperature and humidity, set, on the inspection apparatus, the inspection level responsive to the acquired environmental information.

(((6)))

A program causing a computer to execute a process including:
acquiring environmental information on an environment where a printer is installed;
setting, on an inspection apparatus that inspects a printed material on the printer, an inspection level responsive to the acquired environmental information;
calculating an inspection speed when the inspection apparatus inspects the printed material at the inspection level set on the inspection apparatus; and
controlling the printer such that printing is performed at a print speed responsive to the calculated inspection speed.

What is claimed is:

1. A print control system comprising:
a processor configured to:
acquire environmental information on an environment where a printer is installed;
set, on an inspection apparatus that inspects a printed material on the printer, an inspection level responsive to the acquired environmental information;
calculate an inspection speed when the inspection apparatus inspects the printed material at the inspection level set on the inspection apparatus; and
control the printer such that printing is performed at a print speed responsive to the calculated inspection speed.

2. The print control system according to claim 1, wherein the processor is configured to:
if a plurality of printing lines respectively including printers are present, select, by referencing the print speeds respectively set on the printers, from the printers a printer that is to execute a new print command and
cause the selected printer to execute the new print command.

3. The print control system according to claim 2, wherein the processor is configured to:
if a print command is executed using a subset of printing lines, select, by referencing the print speeds respectively set on the printers, from the printers a subset of printers that is to execute a new print command and
split the new print command and cause the selected subset of printers to execute the split new print commands.

4. The print control system according to claim 1, wherein the environmental information comprises temperature information and humidity information, and
wherein the inspection level is set in accordance with at least one of an inspection item, an inspection criterion or an inspection accuracy, the inspection item indicating an item of the printed material that serves as an inspection target, the inspection criterion being a standard according to which a pass-or-fail judgement is performed on the printed material, the inspection accuracy used in inspection.

5. The print control system according to claim 4, wherein the processor is configured to, in accordance with a table where the inspection level is listed on each combination of temperature and humidity, set, on the inspection apparatus, the inspection level responsive to the acquired environmental information.

6. A non-transitory computer readable medium storing a program causing a computer to execute a process, the process comprising:
acquiring environmental information on an environment where a printer is installed;
setting, on an inspection apparatus that inspects a printed material on the printer, an inspection level responsive to the acquired environmental information;
calculating an inspection speed when the inspection apparatus inspects the printed material at the inspection level set on the inspection apparatus; and
controlling the printer such that printing is performed at a print speed responsive to the calculated inspection speed.

7. A method comprising:
acquiring environmental information on an environment where a printer is installed;
setting, on an inspection apparatus that inspects a printed material on the printer, an inspection level responsive to the acquired environmental information;
calculating an inspection speed when the inspection apparatus inspects the printed material at the inspection level set on the inspection apparatus; and
controlling the printer such that printing is performed at a print speed responsive to the calculated inspection speed.
